(19) United States
(12) Patent Application Publication
(10) Pub. No.: US 2010/0100406 A1
(43) Pub. Date: Apr. 22, 2010

(54) METHOD FOR PROTECTING PERSONAL IDENTITY INFORMATION

(76) Inventor: Beng Lim, Stockholm (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 12/581,123

(22) Filed: Oct. 17, 2009

Related U.S. Application Data
(60) Provisional application No. 61/106,999, filed on Oct. 21, 2008.

(51) Int. Cl. G06Q 20/00; G06Q 10/00

(52) U.S. Cl. 705/7; 705/44

(57) ABSTRACT

The method is for an identity security system. A user sets up a permanent user-profile that has a personal identify number, in his personal ID security pod via a security website. The user uploads one or more photos of the user. An identification-check entity sends an identify request, including the personal identify-number to the website. The security website retrieves the photo associated with the user based on the personal identify-number and displays the photo for the identification-check entity.

### PRIOR APPLICATION

This US utility patent application claims priority from U.S. provisional patent application No. 61/106,999, filed 21 Oct. 2008.

### FIELD OF INVENTION

The present invention relates to a method for protecting personal identity information, verifications and transactions and eliminating identity theft.

### BACKGROUND AND SUMMARY OF THE INVENTION

Identity theft and other similar crimes is the No. 1 and fastest growing consumer crime according to the Federal Trade Commission (FTC) is becoming a major problem in today's society. There is presently no effective method for protecting personal identities (IDs) from identity thieves and from crimes and frauds arising from the use of stolen identities or data/ID breaches. Data breaches in the U.S. over the last two years have exposed information from well over 220 million personal Ids/records. This is equal to the number of people over the age of 18 in the U.S. Virtually every adult in the U.S. has personal (ID) information that has been exposed and is open for possible fraud anytime in the future. In other words, identity is much more than just credit report.

People often assume that because personal identities are recorded or often found on pieces of papers, forms and in computer databases, securing or shredding pieces of paper will therefore protect a person from identity theft or that securing databases and computers will also secure personal identities that are stored in databases. That is a wrong assumption.

The reality is personal identities can be read and memorized and therefore be stolen upon sight by insiders working at these offices without stealing the actual pieces of paper or stealing and hacking the computer.

Any insider working at the bank, passport office, IRS, medical clinic, DMV, school, university, or loyalty and membership clubs, etc. can read and steal any personal identity written on any piece of paper or from computer records on display on millions of computer screens without the victim becoming aware that his or her identity has been stolen and without the knowledge of the bosses of those organizations.

The conventional thinking is to secure personal IDs by trying to keep them secret and away from ID thieves. The simple illustration above shows that it is impossible to keep personal IDs a secret when they are on display to millions of insiders sitting in front of millions of computer screens.

So if it is impossible to try and keep personal IDs a secret, the traditional fallback is to look for signs of unauthorized use of stolen IDs. They look for signs of crime or fraud arising or committed using stolen identities. They might appear as an entry in the personal credit reports of ordinary citizens or in the credit card monthly statements. But that is also flawed.

Alternatively they ‘freeze’ or ‘flag’ their credit reports so that financial institutions would have to contact the owner of the credit report personally to seek permission to issue a new credit card or car loan.

But not all fraud or crime arising from the use of stolen identities appears on credit reports. If an insider at a bank decides to issue new credit cards with stolen identities to his partners in crime, or sell them on the internet, he can do so without raising any warning on the credit report.

Medical ID theft, getting married and getting new employment using stolen IDs are just a few of the many increasing trends in ID Theft that do not appear on credit reports.

When illegal immigrants or criminals use stolen identities to get married, to commit medical fraud, to seek employment, to rent a house or subscribe to a mobile phone, internet, cable TV, and more, these activities do not appear on credit reports. Such crimes and fraud arising from use of stolen identities are often undetected until years later and are just as devastating to the victims.

Personal IDs are not like our email password e.g. (eru76578dnfyh) and not like a secret grandmother's recipe for a special cake. We set our email password to memory and use our grandma's secure recipe now and then and we keep the recipe in a locked place in between use.

Our personal IDs like our names, birth-dates, social security number, credit card numbers, etc. are shown and given away on a daily basis to prospective employers, cashiers at shops and restaurants, on club membership forms, school registration, university registration, insurance companies, utility companies, mobile phone companies and many other organizations like the department of birth department, transport, immigration and so on. We show or give them our ID in order to use their services.

Our IDs are open to almost everyone working in those offices (insiders) and not all of them are totally honest. Any of the insiders can steal and use our IDs and we have no control over the security of our IDs at those places. Our personal IDs are out there and beyond our control.

The owners of personal IDs have the (most) vested interest to protect his or her own ID from ID theft and unauthorized use. Not the companies that use our IDs as a way to identify their customers. Companies do not have much interest in protecting their customers' identities, unless the law punishes them for loss of their customers' IDs. They are often more interested in selling their mailing lists with all the customers identities for profit.

Personal IDs are already in hundreds or thousands of database and on hundreds and thousands of pieces of paper, forms, reports, documents, etc. at the school, university, employers, credit card companies, utility companies, mobile phone companies and hundreds of other places.

So how does one secure something that is already out there at so many unsafe and unsecured locations? It is definitely not a secret anymore. How does one secure say the license plate number of a car that is openly on display all the time?

Furthermore, once our personal IDs are stolen, they are stolen for life and can be used to commit fraud anytime in the future. The ID thief could copy or remember our ID forever. It is not like a physical property—a bicycle which can be recovered after it has been stolen. So once a personal ID is stolen, it cannot be recovered or restored or protected. We are a victim for life.

ID Theft is the fastest growing consumer crime in the US and probably the rest of the world as well. ID Theft is the No. 1 consumer crime in the US. ID Theft is a crime desperately looking for a real security solution. ID Theft affects between 10-100 million Americans each year. ID Theft is an easy crime with a high return to the criminals. ID Theft is a borderless crime.

The many so-called ‘security solutions’ currently available in the market and offered as subscription services to the public can be categorized into 4 broad groups:
1. Credit reports: monitoring or freezing or flagging. They alert the victim if a suspicious financial transaction such as a new car loan is entered into a person's credit report. But not all activities associated with stolen IDs are recorded in credit reports. E.g. illegal employment, marriages, medical ID theft is not recorded on credit reports.
2. Database trawling. This new service promises the customer that they will trawl public and internet databases for records of the subscriber's personal SSNs, etc. But this is a catch22 situation. If all databases are supposed to be secured as they should be, with limited access to staff only, then such trawling services will not be able to access or trawl such databases for SSNs.
3. Computer infrastructure security such as firewalls, encryptions, anti-viruses, keys etc. A bank's or hospital's database can have the best of the best in firewall, antivirus, encryption, multilevel authentications, etc. but it still cannot stop INSIDERS such as bank officers, medical clerks, and employees, etc. who have authorized access to these databases and therefore access to the IDs of everyone in the databases from committing insider theft. If any of the insiders decide to steal one ID at a time or copy the whole database, they can, because they are insiders with authorized access. They can steal and use the stolen IDs themselves or resell them on the internet to others. So no computer security solution alone or all together can protect us from an Insider theft.
4. Paper shredders, locked letterboxes, etc to destroy or keep securely pieces of paper containing our personal IDs. We can shred every single piece of paper in the house but there are still hundreds of pieces of papers and forms with our IDs at the different offices which are vulnerable to ID theft.

All the so-called ‘security solutions’ have tried to do one of the following:

1. Soft Copies

Securing the computers and databases by using firewalls, encryption, strong rooms, to keep out hackers and unauthorized personnel. But they are still vulnerable to insider theft. The laptop could be stolen or lost. Storage devices such as flash or USB memory sticks can be lost. The ID on display on computer screens could be copied and stolen by insiders and be used to commit fraud.

2. Hard Copies

Keep IDs on paper forms, records from thieves by locking letter boxes, locking filing cabinets, offices, rooms, doors, etc. The IDs can be copied from paper files left open on desks in offices. The IDs are stolen or copied or photographed while the original files or paper are left behind without raising suspicion of ID Theft.

3. Others

Looking for evidence of unauthorized application for new credit cards, loans etc. in credit reports.

Every so called anti-ID theft ‘security solution’ tried to keep IDs from prying eyes but all IDs are open to prying eyes of insiders and often insiders are the criminals who stole the IDs. So trying to keep the IDs from prying eyes or keeping them in the secure computer box is a futile exercise because any insider can steal one ID at a time or steal the whole database.

One object of the present invention is a system and method for securing personal identities from identity thieves and securing ordinary citizens, companies and organizations from becoming victims to crimes and fraud arising from the illegal and unauthorized use of stolen personal identities.

Personal IDs can also be lost when companies and their staff lost their laptops, storage media, memory sticks, etc. The system of the present invention will also stop crime and fraud arising from the use of lost personal IDs.

The present invention relates to the field of security for personal identities, identity theft, medical ID theft, and crime and fraud arising from use of stolen IDs.

In particular the present invention relates to a system and method for stopping stolen or lost or other people's personal identities from being used to commit fraud and other illegal unauthorized activities. To secure credit cards, debit cards, checking accounts, SSNs, passport numbers, driving license numbers, birthdates, emails, and all other personal IDs. To stop criminals, illegal immigrants and others from using stolen identities to get married, to get employment, to get free medical care, to rent an apartment or car, to subscribe to new mobile phones, satellite TV, utilities. To stop the use of stolen IDs to apply for new credit cards, car loans, mortgages, driver licenses, passports. To buy airline tickets, new TVs, cars, and more.

To stop the fraud before they happen rather than looking for signs of fraud arising from the use of stolen identities in credit reports.

The method and system of the preset invention assumes that it is useless to try and keep IDs a secret from viewing by others. It is useless to shred papers at home when there are more papers at the offices with our IDs on them. It is useless to secure computer databases because IDs are on display on millions of computers screens to millions of insiders and office workers.

The method and system of the present invention further assumes that all IDs are already in the hands of strangers or already stolen and waiting to be used anytime in the future to commit fraud. Next week or next month or in two years time whether locally or in another state or another country.

The present invention provides a cheap, secure, individual security pod, residing in a global database and network that enables every citizen in the world to store, update and secure their personal IDs from anywhere, anytime.

The present invention enables any company or organization from anywhere in the world to register and be authorized to use the system. The company can then securely access the system to verify any personal identity presented at any point of payments, applications, transactions, etc. to secure their transactions and to eliminate fraud and losses arising from use of stolen IDs, anywhere, anytime.

The present invention will stop and catch criminals from stealing and using another person's identity anywhere in the world.

The present invention enables any merchant to determine that the person at the cashier paying or the person applying for a job or the person who wants to rent a house is the person that he or she claims to be.

The present invention makes the stealing of another person's identities or the possession of a stolen ID a dangerous, unprofitable and useless exercise.

The present invention makes sure that any person trying to impersonate another person and using a stolen ID cannot get away with the crime and will be arrested.

The present invention makes sure that once an ID has been stored, in a personal security pod, it can never be changed or deleted or destroyed.

The present invention will enable verification of personal IDs anywhere in the world where there is an internet connection.

The present invention will secure all existing (billions of) credit cards, debit cards, passports, driver licenses, identity cards, social security cards, medical insurance cards, etc. without the need to make any changes or upgrades to those identity documents thus saving much costs, convenience and time. By storing all their Identities—SSN, card numbers, etc. into their security pods, all those cards and identities are secured immediately.

The present invention does not require the user to carry any new card or document or anything, etc.

The present invention will secure the person even if he or she lost his or her password and code to access his or her security pod. The thief or person who has stolen the password or code cannot use the security pod, unless he or she uploads his or her own photos or details. The thief cannot change or delete anything already in the security Pod or any new IDs he or she might upload.

The present invention allows another family member or friend or employer or Police to ‘endorse’ or act as a ‘referee’ or certify the Security Pod owner.

The present invention puts the security, privacy and control of use of his or her personal IDs in his or her personal control or hands.

The present invention ensures that the person is who he or she claims he or she is.

The present invention will eventually eliminate fake ID documents and eliminate ID Theft to ZERO.

### BRIEF DESCRIPTION OF THE FIGURES

FIG. 1 is a schematic view of the control databases;

FIG. 2 is a schematic view of the information flow of the present invention particularly during the user registration;

FIG. 3 is a schematic view of the information flow of the present invention particularly between the user and the merchant; and

FIG. 4 is a schematic view of a secured online transaction.

### DETAILED DESCRIPTION

The security system of the present invention is based on a secured and large computer database structure and the secured Internet communication infrastructure that will enable global delivery and access to millions of individual privately created, owned and controlled security pods and enables secure accurate verification and authentication of personal Identities.

To secure his or her personal IDs, any person can reach and access the system via a secure website on the Internet. They register online to open a new account (or subscription) like they do to open a new email service like Yahoo or other services on the Internet.

They provide the following to successfully register themselves:
1. Name in full
2. Address
3. State
4. Postcode/Zip code
5. Telephone
6. Email
7. Password and more

Like they normally do when they open their own personal Yahoo email account or Myspace and Facebook account. However, this is where the similarities end. With Yahoo email, eBay, Myspace or Facebook, anyone can use stolen or fictitious information to open an account. That is why there is so much fraud and crime at those websites.

To use this invention, the subscriber must use his or her real IDs only. Using a stolen or fake ID is a crime punishable by existing law with a jail term. The present invention cannot be used to commit fraud. Anyone trying to do so will be caught and will not be able to use their security pod and worse—be arrested and jailed and be listed or black listed as an ID thief or criminal for ever. This will be explained below.

The subscriber will have full and total control on the content, security and privacy of their personal security pod and account. After registering themselves online, they can create their own security pod online and store and secure as few or as many of their personal IDs as they wish. The security pod is an online, private, secure folder to hold, store and secure the personal IDs of the respective owners. This is not a new experience as our personal IDs, bank account-number, credit card numbers, etc. are already in many databases around the country and often connected to the internet. But for the first time, the owner has full control of his IDs and can secure all of them in one security Pod and the IDs once loaded into the personal ID security pods cannot be deleted or edited.

Each subscriber can create and update his or her security pod. Each security pod allows the subscriber to store one or all of his or her personal identities. The minimum requirement to start a functioning Security Pod is to upload a personal ‘passport’ style photo (a front, upper body and face portrait) of the owner together with another personal ID such as her SSN or credit card number or driver license number. Without the photo the security pod is not functional. The personal identities could be one or all of the following and more:
SSN
Credit card no. 1 number
Credit card no. 2 number
Credit card no. 3 number etc.
Debit card no. 1 number
Debit card no. 2 number
Debit card no. 3 number etc
Driving license number
Passport number
Checking account no. 1 number
Checking account no. 2 number etc
Birth certificate number
Mobile telephone number
Motor bike(s) registration number(s)
Car(s) registration number(s)
Marriage license number
Medical insurance number
Membership(s) number(s)
Flying license number
Boat registration number(s)
Employer's name
Company name
Company(ies) registration number(s)
Identity card number
Citizenship
Citizenship number
Green card number
Tax number
and other identities

The Security Pod owner must update his or her photo regularly or every time he or she changes her fashion or hair style. All the data and identities in the security pod are classified into two groups:

1. Public viewable/accessible
a. Photo
   2. Non-public, non-accessible data
a. All other personal IDs
b. Verification logs
c. Entry logs
d. Verifiers' details

All entries, including all personal IDs, name, address, etc. are double entered to eliminate typo-errors. All IDs entered into the system are double checked for double entry by the same person or by another person. All IDs in the system are unique and not duplicated since all IDs are unique to the individual. No two people can have the same credit card number or passport number, etc.

This unique security feature will stop and prevent criminals from trying to defeat or cheat our security invention or system. It will also defeat the purpose of hacking the system. All photos, personal IDs, details, etc. entered into the personal security pods are:
1. Non-editable—cannot be edited ever
2. Non-delete-able—cannot be deleted ever
3. All new identities, such as a new credit card number or a new telephone number are entered as updates and will be stored with the old IDs.
4. Nothing can be deleted or edited or changed

This feature will stop and prevent the Security Pod owner or criminals and organized criminals from opening and creating new security pods using stolen identities to commit crimes and fraud and then to return to delete or change the photos or personal identities after the fraud or crime has been committed to erase the evidence or to defeat the system.

The only way for a criminal to try and use the security pod to commit a fraud or ID Theft is to open an account and then to deposit at least one high quality photo of the criminal himself or herself into the system. To emphasize—In order to commit a crime and use a stolen ID using our security system, the criminal must first upload a high quality photo of himself together with the stolen ID into his security Pod. That photo will incriminate him and provide the Police or FBI with the best evidence to arrest the criminal. Without his own photo, he cannot use the stolen ID to commit any crime or fraud. After committing the crime, he cannot remove or edit or replace the photo or stolen ID he previously uploaded. That photo will also be posted on our security system's black list of criminals for ever. It is easier and safer for him to walk into the store with a gun and commit an armed robbery.

The last thing any criminal want is to have his face captured on CCTV or worse, to personally upload his own high quality portrait into a law enforcement security system. Criminals will find that it is safer and more productive to revert to older ways of committing crime. They will stay away from ID Theft. The system of the present invention will also identify and record the ISP and computer ID of the user.

Nothing in the security pod can be deleted. Once the citizen has uploaded their own photo to the security pod, the photo cannot be deleted. If the photo is used in combination with a stolen ID, such a person is guilty of ID Theft and fraud or impersonation and can and will be reported to the police and FBI and be arrested since he or she has committed identity fraud. A crime that is punishable by existing Anti-ID Theft laws. To remove a photo or ID from the security pod, the creator or owner of the Security Pod must go to court, initiate legal action or make a police report to demand that we delete his photos and ID from the system.

Upon deletion from the system, we retain the right to retain a hardcopy of the Security Pod with a trustee in case future crimes are detected after the Security Pod has been deleted. The hard copy will be sealed and stored for a period of for example 5 years.

All IDs in the security pods are not accessible except for the photos. When an authorized and certified company or organization or casher register is authorized to use the system to verify customer IDs, the cashier enters the ID (e.g. SSN or credit card number) that the customer or jobseeker presents to the cashier or HR Manager.

The cashier enters that number into the verification query form via a secure webpage. The system responds with the same ID number entered for query plus the photo belonging to that ID. If the photo matches the customer the verification is confirmed as positive. If the photo does not match the customer, the verification is confirmed as negative and an alert is raised. The cashier can also activate his own internal CCTV or other security system to record the criminal. The cashier can also activate his webcam to take a photo of the criminal and send it immediately to us.

The unsuccessful verification is alerted to the SSN owner via sms and email and the police. The unsuccessful verification is also logged and time-stamped with the company, cashier and Security Pod owner's pod. All the other IDs stored in the Security Pod by the pod owner are not displayed to any verifier. Only the photo and the ID in question are displayed during verification. Every Security Pod owner can view all the verification history on his or her own personal security pod anytime.

The security system and databases and Security Pods are at least in triplicate. All the security pods are in triplicate and housed at three different secured locations to provide maximum physical and online security. All security pods that are created and updated are in triplicate at all three locations.

Every Security Pod will have a rating system based on successful and unsuccessful verifications. Every merchant will have a rating system based on successful and unsuccessful verifications. Scores will accrue for successful verifications at:
All points of use
By airlines and travel agencies for passports
Employment applications
Every credit card transaction
All other verifications
And all failed or unsuccessful verifications

The higher the rating, the better the security status of the individual is. The lower the security rating, the higher the security risks of the individual. Such ratings are useful for businesses, for employees, etc. Ratings date back to the day of creation of security pod. Ratings are scored as e.g. 17/17 (successful verification over total number of verifications) A Security Pod owner with less than 100% success verification history shows that someone has been trying to use his ID illegally. A cashier at a restaurant or departmental store with a long history of unsuccessful verification could indicate that she or he has been processing a lot of stolen credit cards—probably from his or her friends which create a suspicion.

In order for anyone wishing to commit ID Theft and fraud using a stolen ID and our security pod, he or she must incriminate himself or herself first by uploading a photo of himself or herself. To commit ID Theft and fraud, the criminal must first create a security pod, then enter the stolen Identity(ies) into the Security Pod with his or her own PHOTO, name, email, ID of his computer, etc. If the ID is already registered with the system, it will immediately raise a ‘silent’ alert and red flag. We then alert the FBI as an ID Theft and fraud is about to be committed and monitor the use of that stolen ID.

The first time that that ID is being entered to be verified at a merchant, an alert will be raised and a local Police could be notified to race to the merchant's location to arrest the criminal. Alternatively the store guard or security will be in place to arrest and hold the criminal until the police arrive. If the ID owner is not registered with us yet, there will be no alert but that does not mean that the system cannot catch the fraudster or criminal. When a person commits the ID Theft and fraud, the fraud can only be successful if the verification cashier or officer check and confirm that the ID presented at the counter matches with the photo and with the physical person. Otherwise the cashier would be a party to the crime and incriminates him or herself as well. If the ID thief is referred (see below) by a friend, then his friend is also a party to the crime.

So if the fraud is detected later by the ID's real owner who subscribe to our security Pod three months after the crime, we still have the photo of the guilty criminal in our system for the FBI to track and arrest. After committing the fraud, the criminal cannot return to his or her Security Pod and delete it or change the stolen IDs or change the photos he uploaded into the Security Pod before he committed the crime. So the evidence that he has used a stolen ID and photo to commit a crime will stay in the system for ever together with his photo. His life in the future will be difficult because his photo will join the gallery of ID Thieves in our black list.

So when the crime is discovered the FBI and police can always come to us and get a copy of his photo, the time and day the ID verification was done, at which merchant, by which staff, etc. A citizen who has not opened his or her security account or protected his or her personal identities in a Security Pod is still protected in this way. We will post the photo of the criminal online for all Security Pod owners and merchants to offer information and help in the arrest—like a neighborhood watch.

Many dumb criminals have had their faces captured on CCTV or surveillance tape. Only the really very dumb criminals would upload his or her own high quality photo with a stolen ID into our Security Pod and then go and commit a crime. A criminal or potential criminal cannot upload another person's photo because he needs his own photo to get a positive verification to commit the fraud. All new potential subscribers will be informed of the very high likelihood of being arrested before they subscribe and create their own security pods.

Since the explosion of ID Theft in the US in the last few years, Congress has been forced to enact new laws to protect the public. These new laws mean that anyone trying to create a security pod using stolen IDs or another person's ID is committing a crime. It amounts to the theft and illegal use of another person's ID, impersonation and is a jailable offence. So the likelihood of a criminal trying to upload his photos together with some stolen IDs is a highly dangerous activity. We are very confident that anyone uploading a high quality portrait of himself is very likely to be caught when we highlight his photo to every Security Pod owner and every company that uses our system. The law will enable us to trace from which computer and from which internet service provider the photo and stolen IDs were uploaded from. That information will also be captured by our system as the security pod is being created.

So any person creating a security pod using stolen ID is committing a federal crime and they should refrain from doing so. We will warn every potential subscriber of the danger they face. We will report all illegal entries as ID crime to the FBI. All illegal double entries will be picked out by the system and be reported to the FBI as well. No one can get away with an illegal entry.

In order for merchants, organizations, employers, landlords, car rental companies, etc. to use our verification service, they must first be registered, the business owners and all their staffs must be registered and each owns a personal security pod in the first place. Every staff from the boss or owner down to the lowest rank employee is included. Criminals who set up fake shop fronts will be trapped in our system as well. These organizations, their managers and staff are issued special login codes depending on their level of authority and purpose of use to enable them to perform specific verification functions. Upon login they are directed to their personal query page. An HR manager can only verify SSN of jobseekers. A cashier can only verify credit card numbers or checking account number of customers. A travel agent can only verify passport numbers of ticket buyers. A bank officer can verify SSN or passport numbers or driving license numbers etc.

All creations, uploads, update and other activities associated with the personal security pod are logged. All verifications, both successful and unsuccessful verifications are logged against the company, the officer and the Security Pod owner. All logs contain the verification officer's details, the time, the day, the id verified, success or failure and the verification ID. The same information is logged with the Security Pod owner. So a Security Pod owner knows and has a complete history of who has been checking or verifying his ID. An unsuccessful verification will lead to an internal alert, a sms and email alert to the Security Pod owner and a formal police report and FBI report or the local equivalent. A duplicate entry of an ID will raise an alert and the system will track the activity of the suspect.

To ensure greater security, people are encouraged to join through an introduction from an existing subscriber/user. By establishing a network of friends all connected and introduced by each other to subscribe to our security pods, we can trace any potential or future fraud. They will not only gain a rating point but also receive an income as a recruiter. People who join through introductions provide us with a link or contact should any crime be committed. They act as references or ‘next of kin’. The recruiter can help us verify the new subscriber.

Verification of ID takes place at the bank or organization or company where business, transactions or recruitment, subscriptions are conducted.

1. The bank must be registered with us first.
2. The bank officers must also be registered with us.
3. A new customer approaches the bank officer and offer his or her ID for identification and verification.
4. The bank officer or HR manager or sales staff who is registered to verify identity, login to our system.
5. After successful log in, he or she enters the customer's identity into the online query or verification form.
6. The result is displayed with the identity being verified together with a photo.
7. The cashier or officer verifies whether the photo on display is the same as the person standing in front of him.
8. The cashier can also click a button and the webcam will take a photo of the customer and store it in the system for future reference.
9. If uncertain the officer must call a senior officer or ask for a second ID to be verified.
10. The cashier clicks positive or negative to record the verification.
11. The cashier can also click her own in-house button to summon the security guard if the verification is negative.
12. The verification is logged against the ID owner, the company and the cashier and time stamped.
13. The cashier or officer continues with the next customer and verification.

The present invention also secures all online purchases. When a security Pod owner purchases online, he or she can choose to use our unique membership number instead of his credit card number. Online ecommerce sites can come to an agreement to be connected with our Security Pods. The security between the merchant and our system is the same security that inter-bank banking systems are protected from each other. Our system if it is connected to the merchant's ecommerce machines will automatically send the credit card and delivery information to the merchant's purchase form. So when a criminal steals a credit card number, he cannot use it online to make an illegal purchase because the credit card owner's billing address and delivery address are automatically filled in.

Furthermore a confirmation email is send to the card owner email from our site. We can also send the confirmation sms to the Security Pod owner's mobile phone. Another higher level of security is added on delivery. When the parcel is delivered to the purchaser, the delivery man can key into his portable device a unique number generated during the purchase and printed on the delivery docket. That unique number will call up and display the photo of the purchaser. The delivery man can match the photo to the recipient before handling over the goods to the purchaser. Alternatively that photo can be printed as a postage stamp on the parcel or an airline ticket or movie ticket etc. This security methodology can also be applied to other applications.

All existing social networks, like Myspace, Facebook and others are filled with false identities, fake persons, pedophiles, rapists, thieves, etc. All our Security Pod owners are verified genuine real persons and they will be given a free account in our new social networking site. This way unlike other social networks, our network consists of real persons who you can trust and know who they really are. They can still date and do other things at their Facebook and Myspace profiles and other dating sites for other activities. But we provide a unique secure and real community and network . . . where every 19 year old man is who he claim he is—and not a 50 year old man pretending to be a 19 year old looking to chat up young girls or boys. Unlike eBay, all our members are genuine sellers and buyers. We can help eBay eliminate all fake accounts and criminals. We can eliminate online fraud. All security Pod owners are given a free secure email at our domain. When a person receives an email from our domain, they know that it is not a spam or a Phishing email.

All Security Pod Owners can view all the verifications done on his personal identities. There is a log of unsuccessful verifications There is a log of unsuccessful verifications. The log show the merchant's name, the manager's name and the cashier's name, the time, date, etc. The Security Pod owner can print out his log and visit and query the merchant who has tried to verify his or her identities, why, for what reasons, etc.

The security pods will only be activated and functional after a photo has been uploaded together with at least one personal identity e.g. a credit card number. The photo must pass a quality test to ensure that the person is easily identifiable. Every new entry will have their photo physically verified by an employee to ensure that the photo matches the quality requirement and the photo will be watermarked on acceptance.

By entering a stolen ID, e.g. stolen credit card number, SSN, etc. to create a security Pod, it would trigger a red flag and theft alert in our system which the ID Thief or criminal cannot see. A second entry of any identity whether it is a SSN, a passport or driver license number etc, will also raise an alert. We will watch the ‘stolen ID’ for both Security Pods. The moment the ID is entered for verification, the system will trigger an ‘ARREST ALERT’ or a similar warning.

The cashier must press an internal in-house emergency button to alert its in-house security and the merchant should take immediate action:

1. Arrest and hold the ‘user’ until police arrive
2. Take a CCTV video of the suspect
3. Take a photo of the suspect
4. Make a local police report
5. Make a FBI report
6. Make a FTC report

We will alert the police to visit and question the second ID owner. The matter is now a Police matter as an impersonation and probable ID Theft was committed. Upon final police report, we will restore the real owner and blacklist the ID thief. All accredited and certified merchants must also have a merchant Security Pod, a certified logo on their website and a logo on their physical shop door. All merchants' staffs must each have a personal SECURITY POD. The Security Pod is owned by the individual and not the company since identifications are the properties of the individual. All merchants access the security system through SSL security or via a secure virtual network.

Security Pod owners can take the additional step of placing an alert on his or her Security Pod if he or she has lost a credit card or passport etc. Security Pod owners can place an individual alert to:
Not approve any financial transaction,
Not approve any new credit cards,
Not subscribe to a new mobile phone,
Not subscribe to broadband internet,
Not approve any airline ticket purchase,
Not approve any car loans,
Not approve any student loan,
Not approve any mortgage,
Not approve any job application
Not approve any online transactions and more

When a merchant sees those remarks, they should not approve the transaction even when the verification is positive. This is another level of security. Alternatively, an owner can use his or her subscription number to automate online purchases. Online purchases will seek additional confirmation via Security Pod owner's secured email.

All merchants must establish a prepaid credit account to enable their verifications. They open an account with a credit deposit from the company or personal credit card which they have previously registered when creating their own Security Pod. The monetary deposit will pay for their verification fees. Just as every credit card transaction incurs a fee and an additional fee if it is fraudulent. All verifications that help the merchant eliminate fraud and losses will also incur a fee. This is a fee well spent.

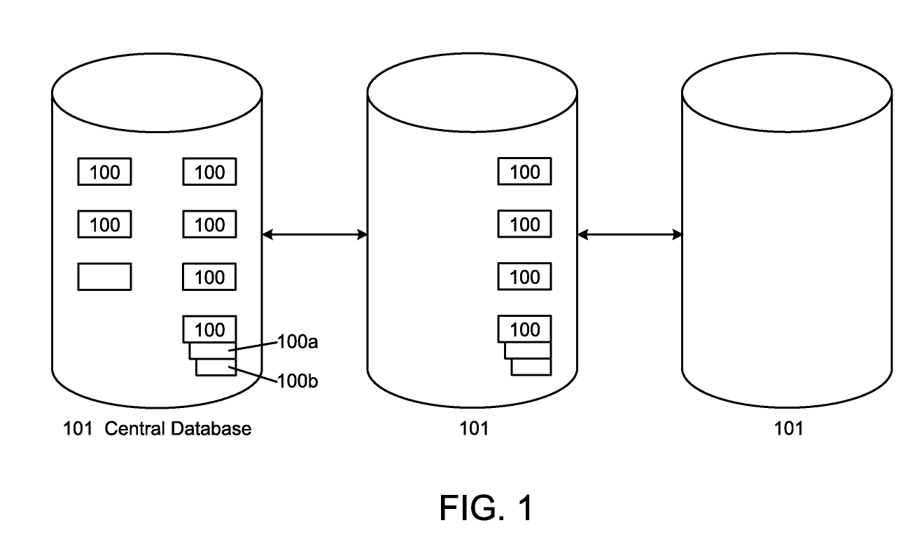

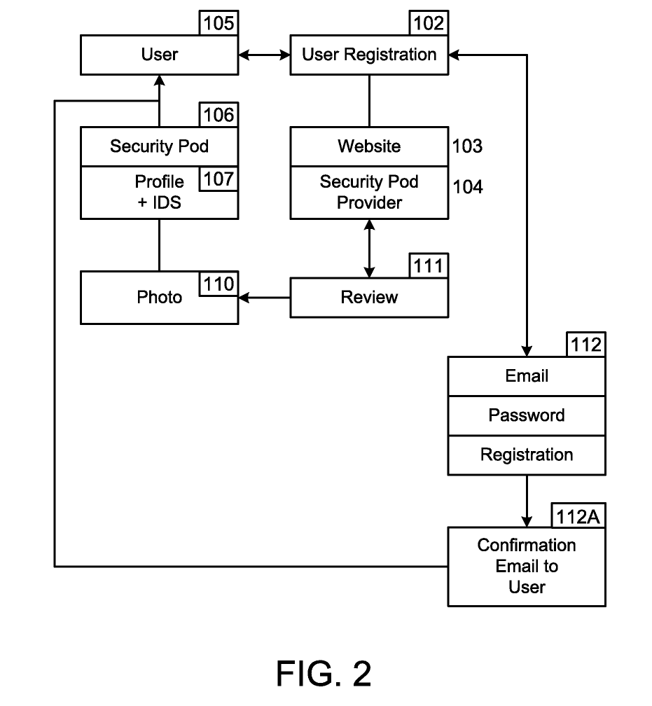

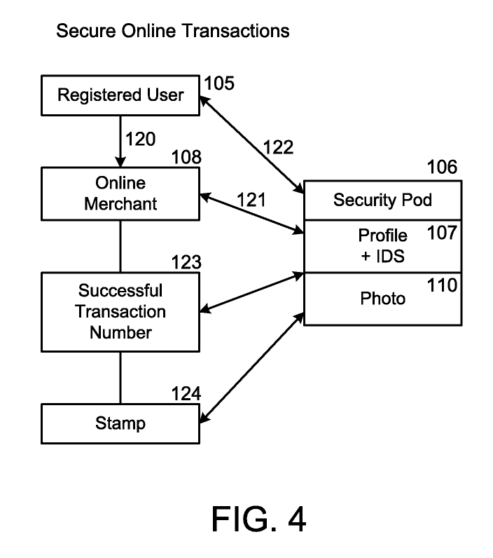

The method 100 of one aspect of the present invention may be summarized as schematically outlined in FIGS. 1-4. The Personal ID Security Pods (100) are unlimited numbers of individual folders or files in a central database (101). Each Security Pod is identified by a user name (100a) and password (100b). The system is synchronized or replicated in triplicate (101) at different locations or more for security and efficiency reasons. Each Security Pod enables the registered owner to upload, store and secure one or all of his personal Ids.

In a user registration step 102, the individual user 105 registers at the security pod provider 104. The user may first visit a website 103 of the provider 104 to key in the user's email address and create a unique password. A confirmation (112a) of the registration is then sent by the provider 104 to the user's email address. The user activates the confirmation received that includes a hyperlink to an empty security pod 106. The user 105 is then asked to provide personal information or profile and Ids 107 such as, name, address, passport number, mobile telephone number, credit card numbers, social security number, car registration and other such personal information. The user may even be asked to enter the information twice to avoid typographical errors. The user then submits the personal profile and IDs (107) to the personal security pod in the secured website 103 of the provider 104. An important feature of the present invention is that the user cannot change or delete any information in the profile/security pod once it has been uploaded into his personal security pod and submitted to the website 103. The user 105 is also asked to provide a clear photo 110 of the user that may, for example, be 6″×4″ and the photo quality should be at least 300 dots per square inch (dpi). The photo 110 must first be approved by the provider 104 in a review step 111 to avoid photos that, for example, are too dark or where the users wear sunglasses etc. The profile/security pod 106 is not activated until an acceptable photo 110 is uploaded to the security pod 106 into the central database via the website 103. The provider 104 then sends an email to the user 105 confirming that the photo 110 has been approved and that the profile/security pod 106 has been activated for use.

The user 105 may read the profile but not modify or delete it. It is possible for the user to add additional information such as adding an updated photo to the profile 106 as the default photo or adding an updated addresses and new credit card numbers etc. However, the previously stored photos, addresses and other information previously entered are still stored in the profile 106.

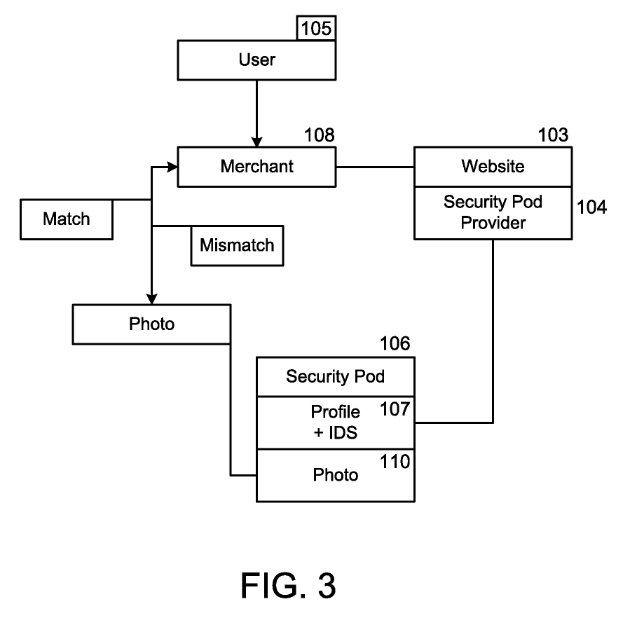

The ID verification is best shown in FIG. 3. The user 105 may during a transaction or application or purchase, etc. be asked to identify him or her by providing information from the profile 106 such as a credit card number or the passport number to an identity identifying entity 108 such as a merchant, bank, airline, or store. The entity 108 enters the credit card number at the secure website 103 and the website 103 responds with a photo 110 of the person associated with the credit card number. The website searches for the credit card number provided to match it with the associated photo 110 of the profile 106 where the credit card number was found. The employee 108 then compares the photo 110 with the user 105 who has been asked to be identified. If the photo 110 represents the user 105 then the transaction is approved and a successful signal (110a) may be sent back to the website 103. In this way, the number of successful identifications or success score rate can be tracked so that the reliability of the user and or merchant may be determined. If the success score rate is relatively low, the entity 108 will be alerted to be extra careful when identifying the user 105 and vice versa.

An important feature of the present invention is that preferably, the entity 108 only receives the photo 110 and no other information from the profile 106 when doing the identity check. This means that the other information in the profile 106 is confidential except the photo 110. It may be possible for the entity 108 to view other previously stored photos also but not any other personal information from the profile 106. When there is no match between the photo 110 and the face of the user 105, the entity 108 will send an unsuccessful match signal (110b) to the website 103 to alert the provider 104 of a possible fraud situation and the user's profile 106 may be black marked or red-flagged. A message may also be sent to the user 105 to inform the user that somebody is trying to user the user's personal information.

The use and the prior activities of the profile 106 are logged or recorded so that it can be seen who has been using the website 103 to upload the photo 110 for identification purposes and all other activities and purposes.

The entity 108, such as the merchant or bank, is preferably registered in a registration step 112 at the provider 104. The entity 108 itself, the business owner and all the staff and employees must be registered. Any person within the entity 108 that wants to use the system 100 of the present invention must first be registered and receive a clearance. The different people within the organization of the entity 108 may be given different access authority. Each staff is given a special personal password 114 to gain access to the system 100 for identification check-ups. The system of the present invention may also be used for secured on-line payment processes.

The secured online transaction of the present invention is described below. When a registered User 105 purchased online at a certified merchant 108, he complete his transaction by entering his Security Pod number 120. His credit card details and delivery details will be auto submitted 121 to the affiliated and certified merchant. A confirmation of purchase email 122 will also be send to the security pod owner to confirm his purchase. Upon confirmation a special transaction number 123 would be generated. That transaction number will appear on all invoices, delivery dockets, etc. to ensure secure delivery of the purchase. A special stamp 124 incorporating the photo of the purchaser can be printed and pasted on the delivery package to enable the delivery person to identify the recipient. Alternatively the delivery person can enter the transaction number into his hand held unit and a photo of the purchaser be displayed to enable him to make a secure delivery.

While the present invention has been described in accordance with preferred compositions and embodiments, it is to be understood that certain substitutions and alterations may be made thereto without departing from the spirit and scope of the following claims.

I claim:

1. A method for an identity security system, comprising:
a user setting up a permanent user-profile, having a personal identify number, at a security website,
providing a photo of the user to the security website,
an identification-check entity sending an identify request,
including the personal identify-number, to the website,
the security website retrieving the photo associated with the user based on the personal identify-number and displaying the photo for the identification-check entity.

2. The method according to claim 1 wherein the method further comprises the security website only displaying the photo (110) and no other information from the user-profile (106) to the identification-check entity.

3. The method according to claim 1 wherein the method further comprises preventing the user from deleting or modifying information in the user-profile.

4. The method according to claim 1 wherein the method further comprises the identification-check entity registering all members of the entity at the website to receive clearance.

5. The method according to claim 1 wherein the method further comprises activating the profile only upon the provider (104) approving the photo.

6. The method according to claim 1 wherein the method further comprises the entity comparing the uploaded photo with the user prior to approving a transaction between the entity and the user.

7. The method according to claim 1 wherein the method further comprises the provider maintaining a success rate of successful identifications of the user to rank a reliability of the user.

8. The method according to claim 1 wherein the method further comprises the entity sending an alert signal to the provider when there is a mismatch between the photo and the user.
